(19) United States
(12) Patent Application Publication
(10) Pub. No.: US 2011/0084163 A1
(43) Pub. Date: Apr. 14, 2011

(54) AIRCRAFT GEAR CADDY

(76) Inventor: William Patrick Macia, Camas, WA (US)

(21) Appl. No.: 12/577,182

(22) Filed: Oct. 10, 2009

(51) Int. Cl. B64C 1/22; B64D 47/00

(52) U.S. Cl. 244/118.1

(57) ABSTRACT

An aircraft gear caddy being removably securely fixable to the bulkhead or other part of a desired aircraft allowing for storage and retrieval during flight of required materials without the need to remove securing devices from the gear caddy.

### BACKGROUND OF THE INVENTION

1. Field of the Invention

The present invention generally relates to an apparatus capable of being easily securely removably attached to the interior of an aircraft allowing secure and safe in flight storage of gear that is useable during flight. More specifically, the present invention relates to an apparatus capable of being easily securely removably attached to the interior of a helicopter allowing secure and safe in flight storage of gear that is useable during flight such maintenance items and especially medical supplies used during emergency medical flights.

2. Description of the Related Art

Generally to achieve required air worthiness for flight all materials must be secured to prevent undesired movement and potential hazards during flight. For aircraft, especially helicopters, used for medical evacuation and transport of patients this means that medical supplies must be stored in hard shell containers and lashed to the floor or deck of the aircraft during flight. When such supplies are needed during flight the containers must be unlashed, opened, the required materials removed, and then the containers sealed, and lashed back down. This creates unnecessary time delay and effort by medical personnel. In addition, the lashed containers take up valuable floor space and get in the way of both patients and medical personnel.

There are numerous means and apparatus for storing regular cargo that is only being transported and not used during flights. For example, U.S. Pat. No. 6,113,031 issued Sep. 5, 2000 to Williams et al. which teaches a cargo bin assembly for use in a helicopter cargo hold. This containerized cargo assembly is secured to the floor of the cargo helicopter and the cargo within the container is secured therein in a manner inconsistent with access during flight.

Also known are cargo storage devices that can be accessed during flight but which require that permanent structures are incorporated into the cabin design. For example, U.S. Pat. No. 7,128,295 issued Oct. 31, 2006 to Scown teaches an overhead storage bin which rotates open and closed.

U.S. Pat. No. 7,309,045 issued Dec. 18, 2007 to Melberg et al. teaches an interior storage unit that rotates into and out of a permanent console unit within an aircraft or other vehicle interior passenger space.
U.S. Pat. No. 7,377,467 issued May 27, 2008 to Saint-James teaches a cargo storage area within a passenger seat console that is accessed by lifting the seat cushion to insert or remove cargo and then lowering the seat cushion back into passenger use position.

There remains a need for a safe secure means of storing such medical supplies and other gear in a manner that provides access during flight without violating air safety standards or putting personnel into a potentially dangerous cabin space.

### DISCLOSURE OF THE INVENTION

The present invention provides advantages and alternatives over the prior art by providing an equipment storage apparatus which is easy to use, provides secure attachment to an air frame or other vehicle or equipment, meets air worthiness standards, frees up the valuable floor/deck space in the passenger cabin, and is inexpensive and easy to maintain.

More particularly, the invention resides in the ability to secure equipment yet allow it to be easily and safely accessed during flight through the use of a novel equipment pack utilizing novel attachment means to attach same to the bulkhead walls, chair or crew bench backrests, ceiling mounts, interior hatch/door walls, walls, and the like.

One object of the present invention is an aircraft gear caddy removably securely fixable to the bulkhead or other interior portion of an aircraft for storage and retrieval of materials during flight comprising in cooperative combination: a gear caddy unit consisting of; a front panel having a substantially rectangular shape with first and second sides and first and second ends, and having at least one gear securing pocket having a gear securable closure and closure device fixedly attached to said front panel; a rear panel having a substantially rectangular shape, of complimentary dimensions to said front panel with first and second sides and first and second ends, said first and second sides and said first end of said front panel and said rear panel being fixedly connected forming a sleeve with a sealable opening at said second end; a center strap fixedly attached down the longitudinal center line of said rear panel having a plurality of belt loop like openings; first and second fixedly attached side straps located parallel to and near each of said sides in having a plurality of belt loop like opening positioned complimentary to said center strap, said first and said second side straps further having a proximal and a distal end and each end terminating in a loop having a D-ring fixed attached therewith; a plurality of T-shape mounting devices removably insertable into a desired belt loop like opening of said center strap and a complimentary belt loop like opening in one said side strap of said gear caddy unit consisting of; a body comprising at least one layer of elastic strap having a proximal end to which is fixedly attached a cross member comprising an outer sleeve having a stiffening member permanently mounted therein, and a distal end having a loop fixedly attaching a mounting hook and further having fixedly mounted a loop of cord allowing stretching of said body thereby allowing mounting said mounting hook to an aircraft member; a substantially rigid panel removably mounted within said sleeve providing a shape substantially complimentary to the aircraft shape at the aircraft gear caddy mounting position; and an adjustable security strap fixedly mounted to each of said D-rings; thereby allowing for the removably secure mounting of said gear caddy unit to the interior of an aircraft.

Another object of the present invention is an aircraft gear caddy removably securely fixable to the bulkhead or other interior portion of an aircraft for storage and retrieval of materials during flight comprising in cooperative combination: a gear caddy unit consisting of; a front panel having a substantially rectangular shape with first and second sides and first and second ends, and having at least one gear securing pocket having a gear securable closure and closure device fixedly attached to said front panel; a rear panel having a substantially rectangular shape, of complimentary dimensions to said front panel with first and second sides and first and second ends, said first and second sides and said first end of said front panel and said rear panel being fixedly connected forming a sleeve with a sealable opening at said second end; a center strap fixedly attached down the longitudinal center line of said rear panel having a plurality of belt loop like openings; first and second fixedly attached side straps located parallel to and near each of said sides in having a plurality of belt loop like opening positioned complimentary to said center strap, said first and said second side straps further having a proximal and a distal end and each end terminating in a loop having a D-ring fixed attached therewith; a plurality of T-shape mounting devices removably insertable into a desired belt loop like opening of said center strap and a complimentary belt loop like opening in one said side strap of said gear caddy unit, further defined as having a portion of said plurality of T-shape mounting devices on each of side sides of said gear caddy unit, consisting of; a body comprising at least one layer of elastic strap having a proximal end to which is fixedly attached a metal cross member, and a distal end having a loop fixedly attaching a mounting hook and further having fixedly mounted a loop of cord allowing stretching of said body thereby allowing mounting said mounting hook to an aircraft member; a substantially rigid panel removably mounted within said sleeve providing a shape substantially complimentary to the aircraft shape at the aircraft gear caddy mounting position; and an adjustable security strap fixedly mounted to each of said D-rings; thereby allowing for the removably secure mounting of said gear caddy unit to the interior of an aircraft.

A further object of the present invention is providing an aircraft gear caddy that may be adapted to various aircraft mounting positions and various aircraft models by changing the removably mounted substantially rigid panel to one having an aircraft compatible shape suitable for the aircraft or aircraft mounting location.

A complete understanding of the present invention may be obtained from the drawings and detailed description that follow.

### BRIEF DESCRIPTION OF THE DRAWINGS

FIG. 1 shows a front view of one embodiment of the gear caddy of the present invention.

FIG. 2 shows a back view of the embodiment of the present invention of FIG. 1.

FIG. 3 shows a side view of the embodiment of the present invention of FIG. 1.

FIG. 4 shows a partial bottom section of the front view of FIG. 1 with showing the shape forming panel being inserted into the gear caddy.

FIG. 5 shows a partial bottom section of the back view of FIG. 2 with showing the shape forming panel being inserted into the gear caddy.

FIG. 6 shows a partial bottom section of the front view of FIG. 1 without the shape forming panel installed in the gear caddy.

FIG. 7 shows a partial bottom section of the back view of FIG. 2 without the shape forming panel installed in the gear caddy.

FIG. 8 shows a perspective view of a shape forming panel for use in the present invention.

FIG. 9 shows a perspective view of the mounting clip part of the T gear caddy mounting member.

FIG. 10 shows a front view of a T gear caddy mounting member with the T stiffing insert mounted and the T stiffing insert ready for use.

FIG. 11 shows a front view of a T gear caddy mounting member with the T stiffing insert being partially inserted prior to final mounting.

FIG. 12 shows a side view of a security strap used on one embodiment of the gear caddy.

### DESCRIPTION OF THE PREFERRED EMBODIMENTS OF THE INVENTION

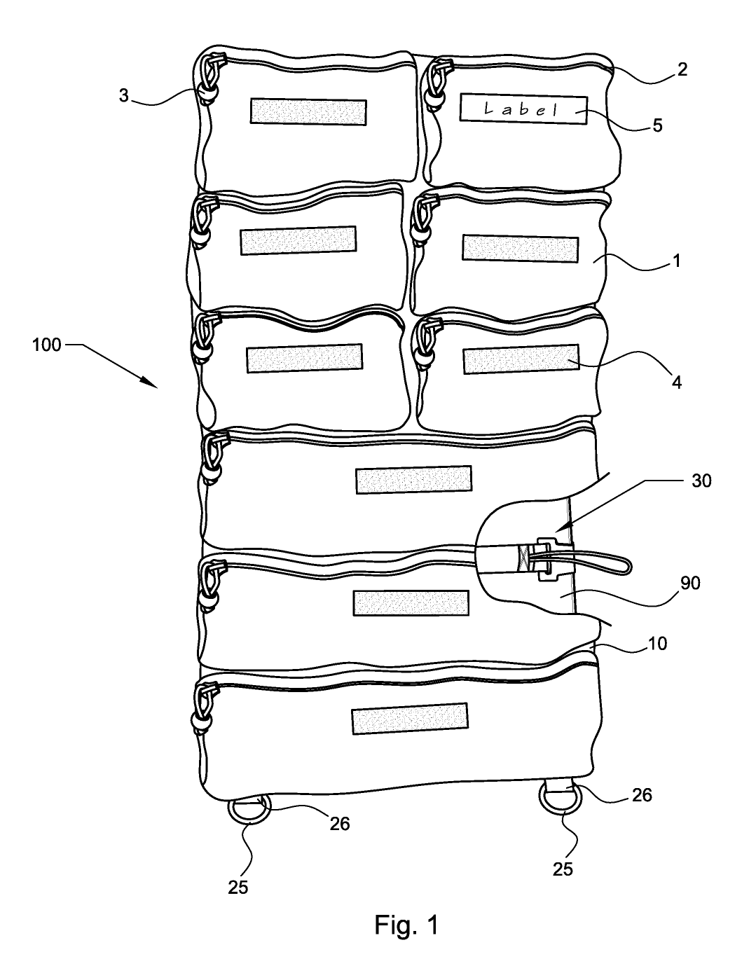

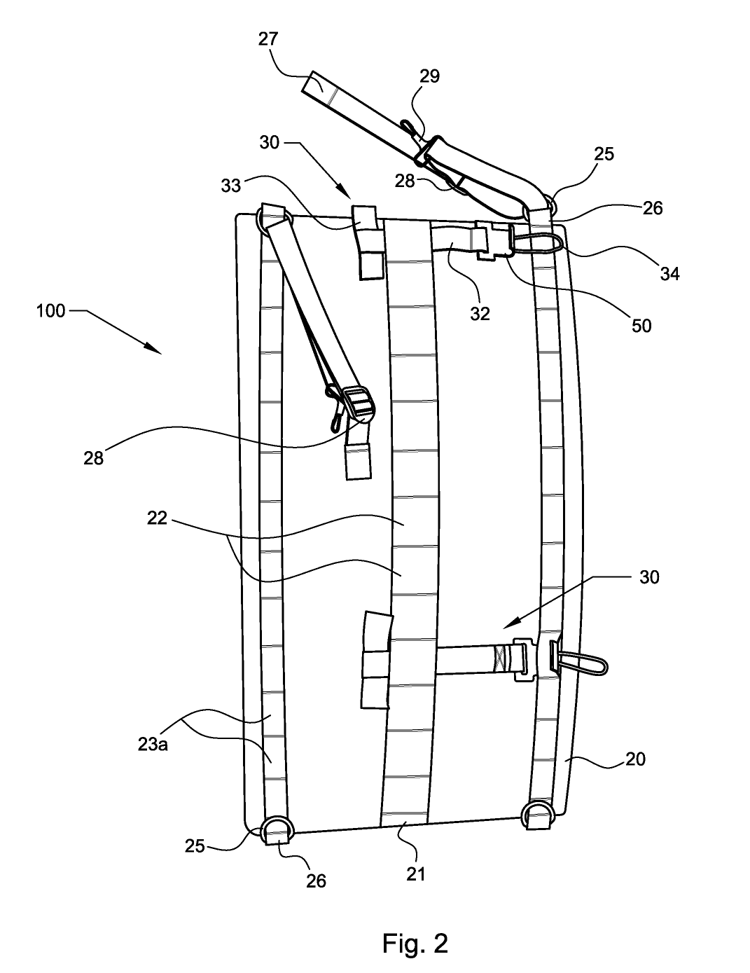

Reference will now be made to the drawings, wherein to the extent possible like reference numerals are utilized to designate like components throughout the various views. Referring to FIG. 1, there is presented a front view of a preferred embodiment of the claimed aircraft gear caddy 100 comprising a front panel 10 having a substantially rectangular shape with first and second sides and first and second ends, and having at least one, and preferably a plurality, of gear securing pockets 1 fixedly attached to said front panel 10. Each of said at least one gear securing pockets 1 having gear securable closure 2 and closure means 3. Further, each of said at least one gear securing pockets 1 has a label attachment device 4 for removably securing a label 5. Also shown in FIG. 1 are D-rings 25 fixedly attached to back panel 20 (see FIG. 2) by attachment loop 26. Further shown, is a cutout showing an aircraft gear caddy mounting device 30 removably mounted to an aircraft interior bulkhead 90.

In FIG. 2 there is presented a rear view of a preferred embodiment of the claimed aircraft gear caddy 100 comprising a rear panel 20 having a substantially rectangular shape, of complimentary dimensions as said front panel 10 (see FIG. 1), with first and second sides and first and second ends. Said first and second sides and said first end of both said front panel 10 and rear panel 20 being fixedly connected forming a sleeve with a sealable opening at said second end. A center strap 21 is fixedly attached down the longitudinal center line of said rear panel 20 having a plurality of belt loop like openings 22 therein formed by a plurality of bar tacks 31. Further presented are first and second fixedly attached side straps 23. One of each of said straps located parallel to and near one of said sides. Further each of said straps is fixedly attached such as to form in a complimentary manner to said center strap 21 a plurality of belt loop like openings 22 along the length of each of said straps formed by a plurality of bar tacks 31. Additionally, said straps 23 each have a proximal end and a distal end. Said proximal and distal ends of each strap 23 have a loop 26 fixedly mounting a D-ring 25. Also shown attached to two of said D-rings 25 are adjustable security straps 27 having an adjustment buckle 28 and a snap connector 29. Also presented is one of a plurality of aircraft gear caddy mounting devices 30 removably attached to aircraft gear caddy 100 by means of a center strap 21 belt loop 22, as well as another an aircraft gear caddy mounting device 30 fully mounted by means of a center strap 21 belt loop 22 and by means of one of said side straps 23 belt loop 24.

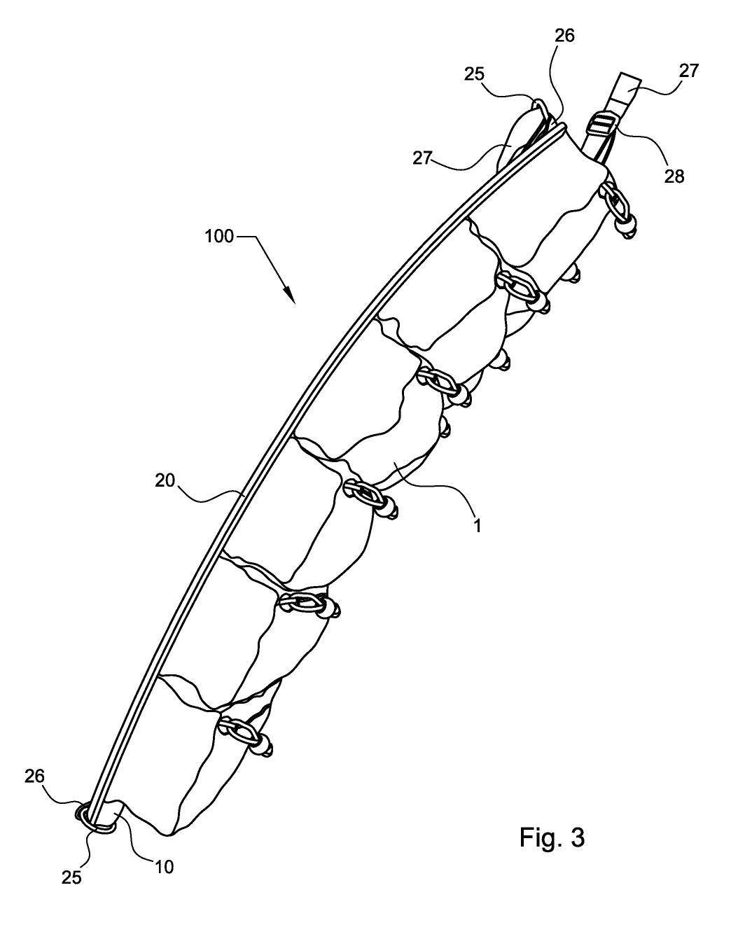

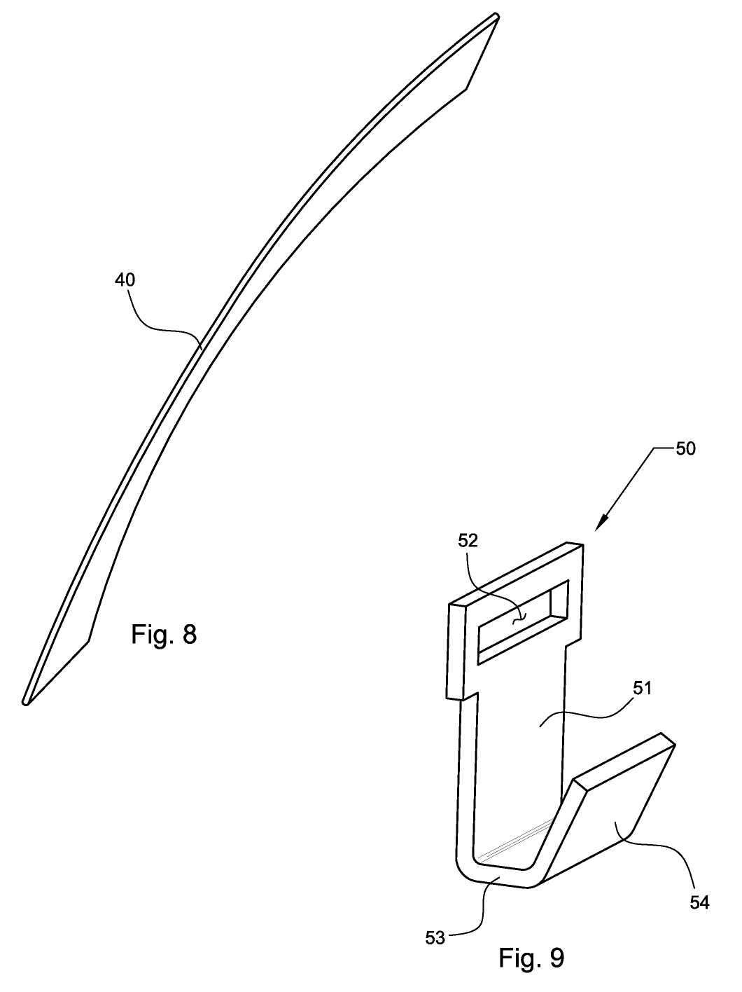

FIG. 3 shows a side view of a preferred embodiment of the claimed aircraft gear caddy 100 comprising a front panel 10 fixedly attached on first and second sides and first end to a complimentary rear panel 20. Also shown is gear securing pockets 1 each having a closure 2 and closure means 3, D-rings 25 fixedly attached to said aircraft gear daddy 100 by loops 26 as well as a adjustable security strap 27 having an adjustment buckle 28 and a snap connector 29. The shape of the aircraft gear caddy 100 is formed by a substantially rigid panel 40 (see FIG. 8) having a size suitable for mounting within the sleeve formed by the construction of front panel 10 to rear panel 20 and a desired curvature to compliment the aircraft wall, door, or bulkhead where it is intended to be mounted. In this embodiment the desired curvature is complimentary to the entrance bulkhead of a Sikorsky UH-60 Black Hawk helicopter.

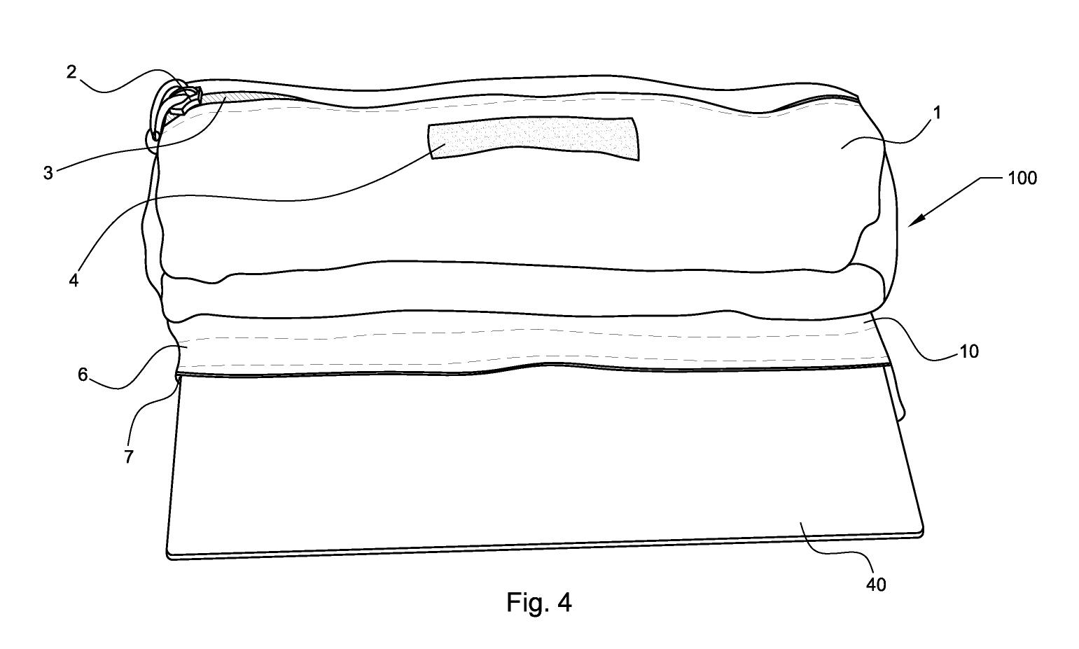

In FIG. 4 is presented a front view of the bottom portion of the aircraft gear caddy 100 showing the substantially rigid panel 40 partially inserted into sleeve opening 7 formed by front panel 10 and rear panel 20 (not shown). Also shown, is one gear securing pocket 1 having gear securable closure 2 and closure means 3 as well as a label attachment device 4. Finally, there is shown the attachment location of the loop portion 6 of a hook and loop closure device.

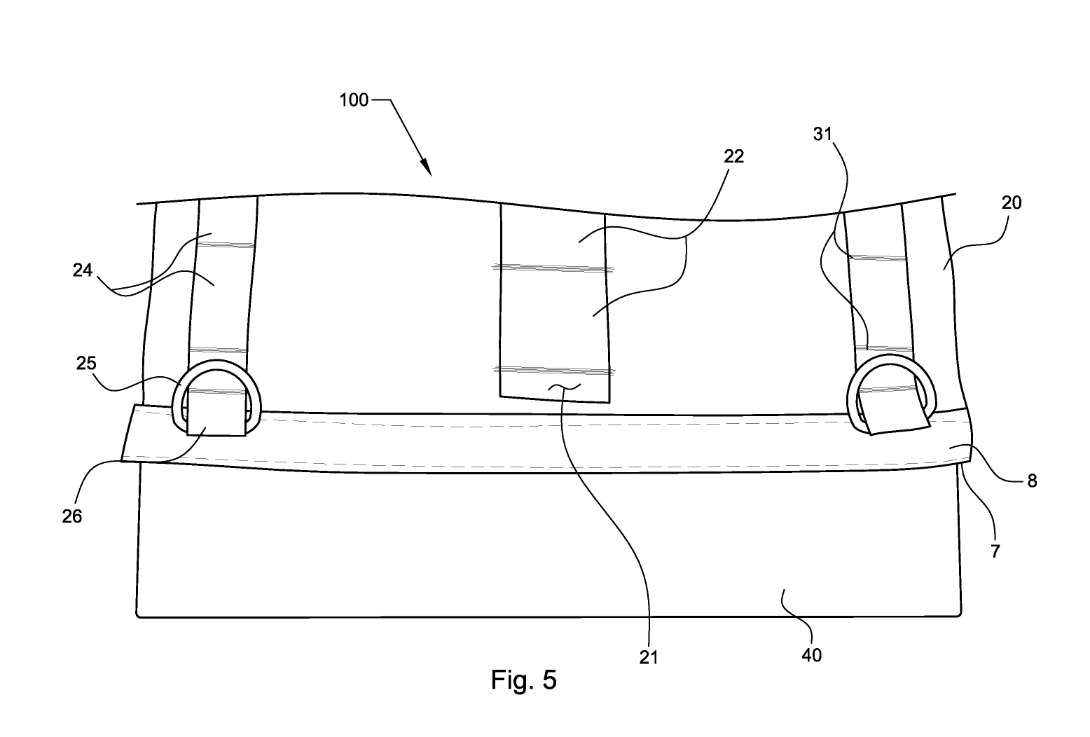

Turning to FIG. 5 there is presented a rear view of the bottom portion of the aircraft gear caddy 100 showing the substantially rigid panel 40 partially inserted into sleeve opening 7 formed by front panel 10 (not shown) and rear panel 20. Also shown are center strap 21 with belt loop like openings 22 as well as first and second side straps 23 having belt loop like openings 24 as well as loops 26 and D-rings 25. Finally there is shown the hook portion 8 of a sleeve closure means fixedly attached to the second end of panel 20.

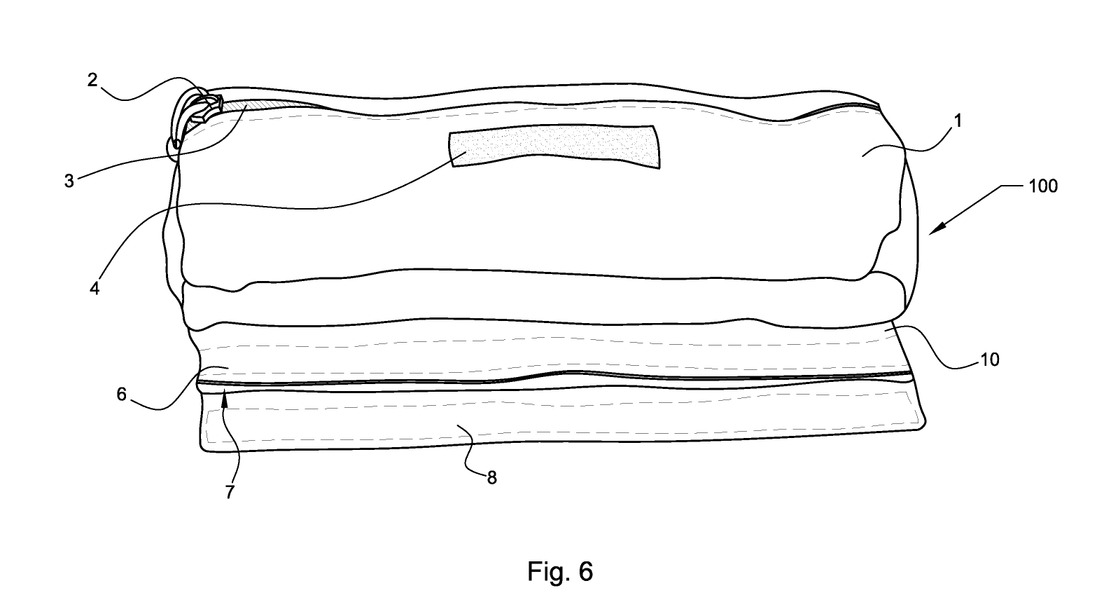

Referring now to FIG. 6 there is presented the bottom portion of a front view of the aircraft gear caddy 100 particularly showing sleeve opening 7, attachment location of loop portion 6, and hook portion 8 of the sleeve closure means. Also shown, is one gear securing pocket 1 having gear securable closure 2 and closure means 3 as well as a label attachment device 4.

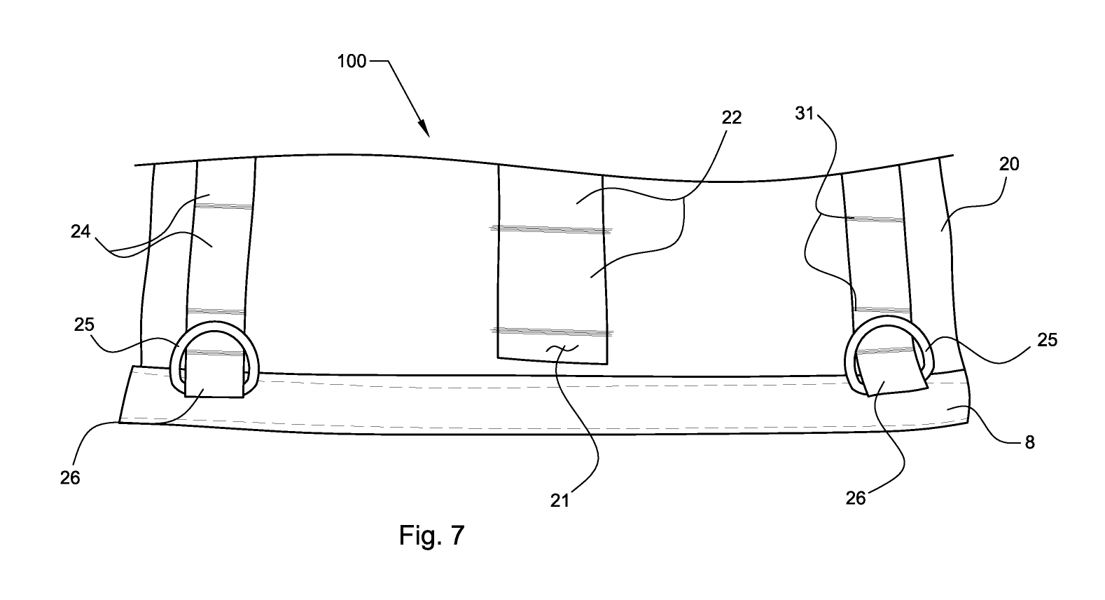

Turning to FIG. 7 there is presented the bottom portion of a rear view of the aircraft gear caddy 100 particularly showing hook portion 8 of the sleeve closure means as well as strap 21 having belt loop like openings 22 and straps 23 having belt loop like openings 24 as well as end loops 26 fixedly securing D-rings 25.

In FIG. 8 there is presented a perspective side view of a substantially rigid panel 40 having a desired curvature suitable for mounting to the entrance bulkhead of a Sikorsky UH-60 Black Hawk helicopter.

In FIG. 9 there is presented a preferred embodiment of the securing hook 50 comprising a shaft portion 51 having a first end containing a bore 52 for permanent attachment to the securing loop 37 of aircraft gear caddy mounting device 30, a bend portion 53 and a second end hook portion 54. The dimensions of the bend portion 53 and the dimensions and angle of hook portion 54 selected to allow secure mounting to a desired portion of a desired aircraft. The dimensions and angle of the presented securing hook 50 being chosen to allow secure mounting to a Sikorsky UH-60 Black Hawk helicopter.

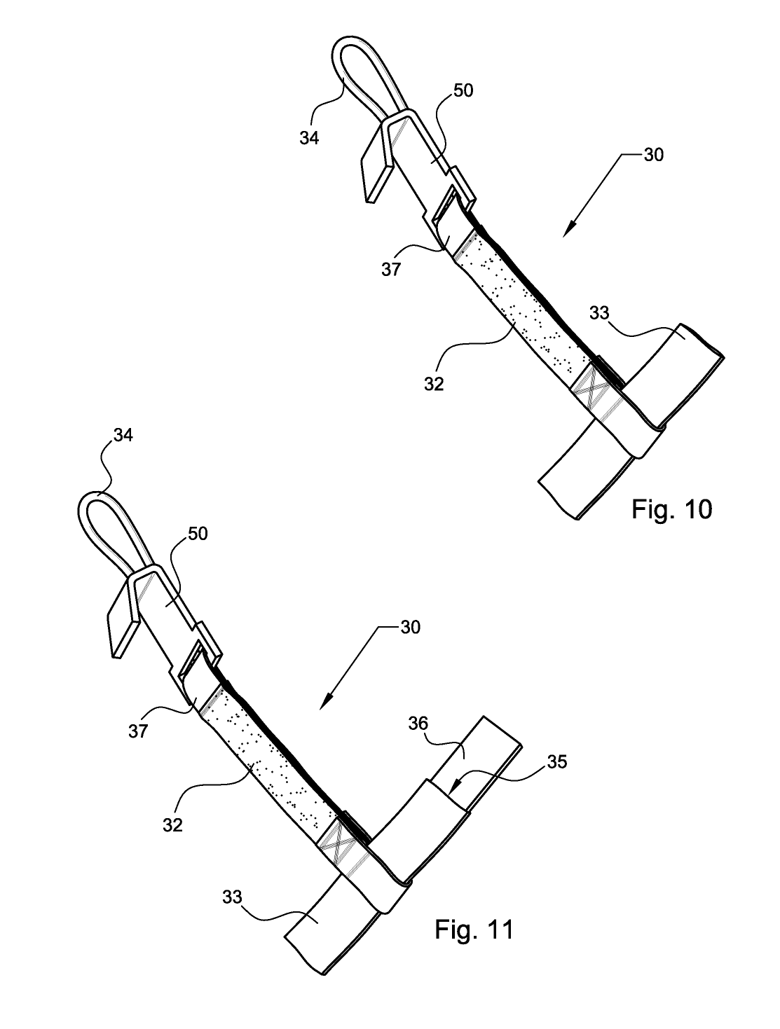

FIG. 10 presents a front view of an aircraft gear caddy mounting device 30 having a generally T shape and comprising a main stem 32 comprising an elastic stretch composition, and having a first end to which is fixedly attached a top bar 33 and a second end to which is fixedly attached a pull loop 34 and a securing hook 50 by means of securing loop 37. Said top bar 33 comprising a sleeve 35 for inserting a rigid member 36 (see FIG. 11) therein and sealing within said sleeve 35. As illustrated here the rigid member 36 (see FIG. 11) has been sealed within said sleeve 35. It is to be understood that the top bar 33 may be simply an unsheathed metal piece fixedly attached to said main stem 32.

In FIG. 11 there is presented a front view of an aircraft gear caddy mounting device 30 having a generally T shape and comprising a main stem 32 comprising an elastic stretch composition, and having a first end to which is fixedly attached a top bar 33 and a second end to which is fixedly attached a pull loop 34, and a securing hook 50 by means of securing loop 37. Said top bar 33 comprising a sleeve 35 for inserting a rigid member 36 therein and sealing within said sleeve 35. As illustrated here the rigid member 36 is partially inserted into sleeve 35.

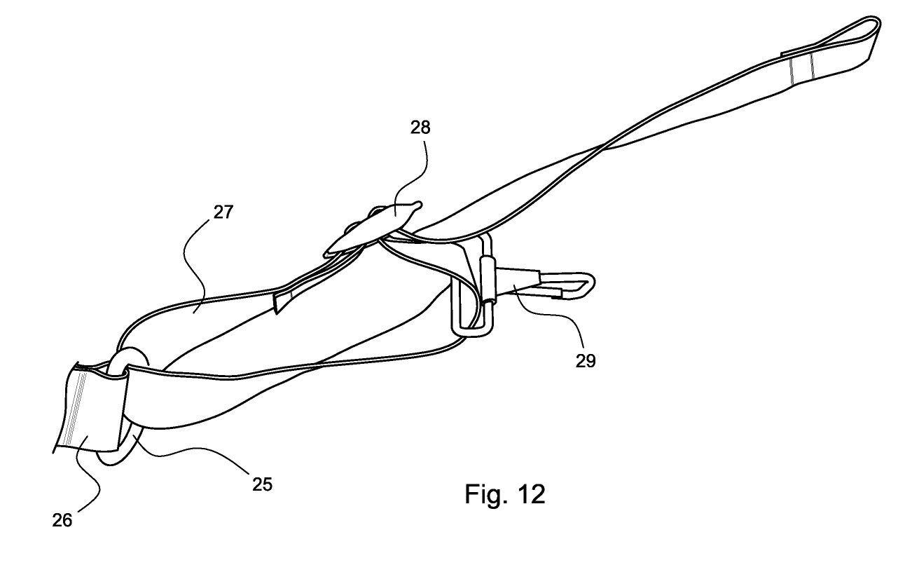

In FIG. 12 there is presented a side view of the adjustable security strap 27 having a length adjustment buckle 28 and snap connector 29 and mounted on D-ring 25 which is in turn secured by loop 26 to aircraft gear caddy 100 (see FIG. 2).

Presently preferred materials for the construction of the gear caddy panels and gear storage pockets are Nomex, Kevlar, and 1000 denier weave Nylon fabrics. The presently preferred elastic is a woven elastic material having a stretch ratio of 2:1. And the presently preferred straps comprise flat nylon webbing with tubular Nylon webbing being preferred for the top bar. Particularly preferred is 1 inch flat webbing for the two side positioned straps and 2 inch flat heavy duty webbing for the center strap. The presently preferred top bar stiffener is sheet aluminum and the preferred panel insert is resin filled fiber glass woven fabric panels. The hooks are preferably made of any suitable metal such as aluminum or steel. The presently preferred hook metal is epoxy powder coated steel.

In practice the claimed aircraft gear caddy for use in aircraft such as, for example, the UH-60 Sikorsky UH-60 Black Hawk, and the Bell 412, is securely removably attached to the aircraft bulkhead or other aircraft feature utilizing a novel retention system comprising a cooperative combination of three straps 21, 23, fixedly attached along the longitudinal axis of a rear facing panel which in turn is located against the aircraft bulkhead or other attaching portion of the aircraft. Said three straps comprise a center strap 21 fixedly attached down the longitudinal center line of said rear panel 20 having a plurality of linear bar tacks at desired intervals along the length of said strap providing loop like openings 22 therein. The two other straps comprise a first and second fixedly attached side straps 23. One of each of said straps located parallel to and near one of said sides. Further each of said straps is fixedly attached such as to form a plurality of linear bar tacks at desired intervals along the length of said strap providing loop like openings 24 therein. Said loop like openings 24 along the length of each of said straps 23 positioned in a complimentary manner to the loop like openings 22 of said center strap 21. Thus, providing the retention mounting means, at the center and both sides of said aircraft gear caddy, allowing removably mounting a desired plurality of mounting devices 30 to the aircraft gear caddy.

A desired plurality of mounting devices 30, in balanced or unbalanced arrangement on each side of said aircraft gear caddy 100, are mounted to said aircraft gear caddy 100 by passing the hook 50 of each of said mounting devices 30 through a loop like opening 22 in the center strap 21 and then through the complimentary loop like opening 24 in one of said edge straps 23 and orientated such that the hook 50 faces away from said rear panel 20 allowing attachment to an aircraft bulkhead or other structure. The mounting device hook 50 is attached to the mounting device top bar 33 via mounting device main stem 32 comprising woven elastic webbing thereby providing the tension required to securely attach said aircraft gear caddy 100 to an aircraft. Presently preferred is a triple layer of woven elastic webbing. The mounting devices 30 are utilized in a balanced, opposing, manner, providing an equal desired number of hooks 50 for mounting the aircraft gear caddy 100 to the aircraft. It is to be appreciated that there may be the same number of hooks mounted on each side of the aircraft gear caddy or an unequal number so mounted. The presently preferred desired number of hooks 50 is four on each side for a total of eight.

Additionally, there is provided a substantially rigid panel 40 having a desired curvature suitable for mounting to the desired location within a desired aircraft. This substantially rigid panel 40 thereby maintaining the aircraft gear caddy 100 in a desired position.

Although the preferred embodiments of the present invention have been disclosed; various changes and modifications may be made without departing from the scope of the invention as set forth in the appended claims.

What is claimed is:

1. An aircraft gear caddy removably securely fixable to the bulkhead or other interior portion of an aircraft for storage and retrieval of materials during flight comprising in cooperative combination:
a gear caddy unit consisting of;
a front panel having a substantially rectangular shape with first and second sides and first and second ends, and having at least one gear securing pocket having a gear securable closure and closure device fixedly attached to said front panel;
a rear panel having a substantially rectangular shape, of complimentary dimensions to said front panel with first and second sides and first and second ends, said first and second sides and said first end of said front panel and said rear panel being fixedly connected forming a sleeve with a sealable opening at said second end;
a center strap fixedly attached down the longitudinal center line of said rear panel having a plurality of belt loop like openings;
first and second fixedly attached side straps located parallel to and near each of said sides in having a plurality of belt loop like opening positioned complimentary to said center strap, said first and said second side straps further having a proximal and a distal end and each end terminating in a loop having a D-ring fixed attached therewith;
a plurality of T-shape mounting devices removably insertable into a desired belt loop like opening of said center strap and a complimentary belt loop like opening in one said side strap of said gear caddy unit and further defined as having a portion of said plurality of T-shape mounting devices on each of side sides of said gear caddy unit, consisting of;
a body comprising at least one layer of elastic strap having a proximal end to which is fixedly attached a cross member comprising an outer sleeve having a stiffening member permanently mounted therein, and a distal end having a loop fixedly attaching a mounting hook, further having fixedly mounted a loop of cord allowing stretching of said body thereby allowing mounting said mounting hook to an aircraft member;
a substantially rigid panel removably mounted within said sleeve providing a shape substantially complimentary to the aircraft shape at the aircraft gear caddy mounting position; and
an adjustable security strap fixedly mounted to each of said D-rings;
thereby allowing for the removably secure mounting of said gear caddy unit to the interior of an aircraft.

2. The aircraft gear caddy removably securely fixable to the bulkhead or other interior portion of an aircraft for storage and retrieval of materials during flight as claimed in claim 1 wherein, said gear caddy unit material is selected from the group consisting of Nomex, Kevlar, and 1000 denier weave Nylon fabrics.

3. The aircraft gear caddy removably securely fixable to the bulkhead or other interior portion of an aircraft for storage and retrieval of materials during flight as claimed in claim 1 wherein, said straps comprise flat nylon webbing, particularly preferred is 1 inch flat webbing for said two side positioned straps and 2 inch flat heavy duty webbing for said center strap

4. The aircraft gear caddy removably securely fixable to the bulkhead or other interior portion of an aircraft for storage and retrieval of materials during flight as claimed in claim 1 wherein, said top bar webbing comprises tubular Nylon.

5. The aircraft gear caddy removably securely fixable to the bulkhead or other interior portion of an aircraft for storage and retrieval of materials during flight as claimed in claim 1 wherein, said mounting hook comprises aluminum or steel, preferably epoxy powder coated steel.

6. The aircraft gear caddy removably securely fixable to the bulkhead or other interior portion of an aircraft for storage and retrieval of materials during flight as claimed in claim 1 wherein, there are an equal number of said T-shape mounting devices on each side of said gear caddy unit.

7. The aircraft gear caddy removably securely fixable to the bulkhead or other interior portion of an aircraft for storage and retrieval of materials during flight as claimed in claim 1 wherein, there are an unequal number of said T-shape mounting devices on each side of said gear caddy unit.

8. The aircraft gear caddy removably securely fixable to the bulkhead or other interior portion of an aircraft for storage and retrieval of materials during flight as claimed in claim 1 wherein, said T-shape mounting device body comprises three layers of elastic strap.

9. The aircraft gear caddy removably securely fixable to the bulkhead or other interior portion of an aircraft for storage and retrieval of materials during flight as claimed in claim 1 wherein, said substantially rigid panel comprises fiber glass.

10. An aircraft gear caddy removably securely fixable to the bulkhead or other interior portion of an aircraft for storage and retrieval of materials during flight comprising in cooperative combination:
a gear caddy unit consisting of;
a front panel having a substantially rectangular shape with first and second sides and first and second ends, and having at least one gear securing pocket having a gear securable closure and closure device fixedly attached to said front panel;
a rear panel having a substantially rectangular shape, of complimentary dimensions to said front panel with first and second sides and first and second ends, said first and second sides and said first end of said front panel and said rear panel being fixedly connected forming a sleeve with a sealable opening at said second end;
a center strap fixedly attached down the longitudinal center line of said rear panel having a plurality of belt loop like openings;
first and second fixedly attached side straps located parallel to and near each of said sides in having a plurality of belt loop like opening positioned complimentary to said center strap, said first and said second side straps further having a proximal and a distal end and each end terminating in a loop having a D-ring fixed attached therewith;
a plurality of T-shape mounting devices removably insertable into a desired belt loop like opening of said center strap and a complimentary belt loop like opening in one said side strap of said gear caddy unit, further defined as having a portion of said plurality of T-shape mounting devices on each of side sides of said gear caddy unit, consisting of;
a body comprising at least one layer of elastic strap having a proximal end to which is fixedly attached a metal cross member, and a distal end having a loop fixedly attaching a mounting hook and further having fixedly mounted a loop of cord allowing stretching of said body thereby allowing mounting said mounting hook to an aircraft member; and
an adjustable security strap fixedly mounted to each of said D-rings;
thereby allowing for the removably secure mounting of said gear caddy unit to the interior of an aircraft.

11. The aircraft gear caddy removably securely fixable to the bulkhead or other interior portion of an aircraft for storage and retrieval of materials during flight as claimed in claim 10 wherein, said gear caddy unit material is selected from the group consisting of Nomex, Kevlar, and 1000 denier weave Nylon fabrics.

12. The aircraft gear caddy removably securely fixable to the bulkhead or other interior portion of an aircraft for storage and retrieval of materials during flight as claimed in claim 10 wherein, said straps comprise flat nylon webbing, particularly preferred is 1 inch flat webbing for said two side positioned straps and 2 inch flat heavy duty webbing for said center strap

13. The aircraft gear caddy removably securely fixable to the bulkhead or other interior portion of an aircraft for storage and retrieval of materials during flight as claimed in claim 10 wherein, said mounting hook comprises aluminum or steel, preferably epoxy powder coated steel.

14. The aircraft gear caddy removably securely fixable to the bulkhead or other interior portion of an aircraft for storage and retrieval of materials during flight as claimed in claim 10 wherein, there are an equal number of said T-shape mounting devices on each side of said gear caddy unit.

15. The aircraft gear caddy removably securely fixable to the bulkhead or other interior portion of an aircraft for storage and retrieval of materials during flight as claimed in claim 10 wherein, there are an unequal number of said T-shape mounting devices on each side of said gear caddy unit.

16. The aircraft gear caddy removably securely fixable to the bulkhead or other interior portion of an aircraft for storage and retrieval of materials during flight as claimed in claim 10 wherein, said T-shape mounting device body comprises three layers of elastic strap.

17. The aircraft gear caddy removably securely fixable to the bulkhead or other interior portion of an aircraft for storage and retrieval of materials during flight as claimed in claim 10 wherein, said substantially rigid panel comprises fiber glass.
